(19) United States
(12) Patent Application Publication
(10) Pub. No.: US 2017/0157801 A1
(43) Pub. Date: Jun. 8, 2017

(54) METHOD AND APPARATUS FOR RECOVERING REINFORCEMENT FIBERS FROM FIBER-REINFORCED PART

(71) Applicant: Hyundai Motor Company, Seoul (KR)

(72) Inventors: June Ho Yang, Seoul (KR); Chi Hoon Choi, Suwon (KR); Sang Yoon Park, Daejeon (KR); Jeong Min Cho, Suwon-Gyeonggi-do (KR); Young Ho Choi, Seongnam (KR)

(21) Appl. No.: 15/263,844

(22) Filed: Sep. 13, 2016

(30) Foreign Application Priority Data
Dec. 7, 2015 (KR) 10-2015-00173347

(51) Int. Cl. B29B 17/02; B05C 9/12; B05C 9/10; B05D 5/00; B05D 7/20

(52) U.S. Cl. CPC B29B 17/02; B05D 5/00; B05D 7/20; B05C 9/10; B05C 9/12; B29B 2017/0293; B29K 2307/04

(57) ABSTRACT

Disclosed is a method of recovering reinforcement fibers from a fiber-reinforced part that includes the reinforcement fibers and is impregnated with resin. The method includes unwinding the reinforcement fibers from the fiber-reinforced part, dissolving the resin impregnated in the fiber-reinforced part, coating the resin-free reinforcement fiber with a sizing agent, and winding the sizing agent-coated reinforcement fibers around a mandrel.

### CROSS REFERENCE TO RELATED APPLICATION

The present application claims priority to Korean Patent Application No. 10-2015-0173347, filed Dec. 7, 2015, the entire contents of which is incorporated herein for all purposes by this reference.

### TECHNICAL FIELD

The present invention relates to an apparatus and method for recovering reinforcement fibers from a fiber-reinforced part, for example, a wasted fiber-reinforced part. The method of the present invention may prevent tangling of the reinforcement fibers and improve recycling of the recovered reinforcement fibers.

### BACKGROUND

Pressure vessels includes carbon fibers manufactured by a filament winding method, and due to the cost of the carbon fibers, recycling of reinforcement fibers such as carbon fibers from the wasted pressure vessels has been required.

In the related arts, there have been many studies on the recycling of reinforcement fibers such as carbon fibers. However, conventional recycling methods may require significant time and cost for collection and treatment of waste fibers. Moreover, tangling of reinforcement fibers such as carbon fiber, which may occur during thermal or chemical decomposition of waste pressure vessels, can be an another problem that makes it difficult to recycle reinforcement fibers recovered from the wasted fiber-reinforced parts.

The foregoing is intended merely to aid in the understanding of the background of the present invention, and is not intended to mean that the present invention falls within the purview of the related art that is already known to those skilled in the art.

### SUMMARY OF THE INVENTION

In preferred aspects, the present invention provides a method of recovering reinforcement fibers from a wasted fiber-reinforced part. The present invention also provides a method of preventing tangling of the reinforcement fibers so that recovered reinforcement fibers can be easily recycled.

In one aspect of the present invention, provided is a method of recovering reinforcement fibers from a fiber-reinforced part. The method may comprise: unwinding reinforcement fibers from a fiber-reinforced part comprising the reinforcement fibers and impregnated with resin; coating the unwound reinforcement fibers with a sizing agent by passing the unwound reinforcement fibers through the sizing agent; and winding the sizing agent-coated reinforcement fibers around a mandrel.

The unwinding may include: swelling the resin in the fiber-reinforced part by dipping the fiber-reinforced part in a swelling agent; dissolving the resin by passing the unwound reinforcement fibers through a dissolving agent as unwinding the reinforcement fibers from the fiber-reinforced part; and winding the resin-free reinforcement fibers using an intermediate winder.

Unwinding in several may include any type of separating the reinforcement fibers from the resin, for example, winding the reinforcement fibers using other winder (e.g. intermediate winder).

The term “sizing agent”, as used herein, refers to an agent that may provide water resistance to a surface of a material, for example, to a carbon reinforcement fiber, as being coated or applied on the surface thereof. Preferably, the swelling agent may be a weak acid.

The term “weak acid”, as used herein, refers to an acid that may dissociate partially or incompletely, and release or donate less amount of proton into a solution, e.g. water solution. The weak acid may have a pKa values greater than about 3, greater than about 4, greater than about 5, or greater than about 6. Exemplary weak acids in the present invention may include acetic acid and formic acid.

The dissolving agent may suitably include a hydrogen peroxide solution and an ionic liquid.

The term “ionic liquid”, as used herein, refers to a solvent including only ionic species, or a liquid salt consisting of ions (cations and anions). Exemplary ionic solvent in the present invention may include cations such as imidazolium, pyridinum, pyrrolidinium, quaternary ammonium, and quaternary phosphonium, but anions may not be particularly limited.

Preferably, a tension of the reinforcement fibers wound by the intermediate winder may be greater than a tension of the reinforcement fibers wound around the mandrel.

The sizing agent suitably may include one or more resins selected from the group consisting of epoxy resin, polyurethane resin, polyester resin, polyamide resin, and nylon resin.

In another aspect of the present invention, also provided is an apparatus for recovering reinforcement fibers from a fiber-reinforced part. The apparatus may comprise: a swelling tank containing a swelling agent comprising a weak acid and swelling a resin impregnated in the fiber-reinforced part is impregnated; a dissolving tank containing a dissolving agent comprising a hydrogen peroxide solution and an ionic liquid and dissolving the resin impregnated in the fiber-reinforced part; an intermediate winder winding the reinforcement fibers from which the resin is removed; a sizing tank containing a sizing agent coating the resin-free reinforcement fibers; and a mandrel around which the coated reinforcement fibers are wound.

The apparatus may further include a tension adjuster that adjusts a tension of the reinforcement fibers such that a tension of the reinforcement fibers wound by the intermediate winder is greater than a tension of the reinforcement fibers wound by the mandrel.

The recovery method of waste reinforcement fibers according to various exemplary embodiments of the present invention may include swelling of resin and preventing tangling of reinforcement fibers by dipping fiber-reinforced parts such as pressure vessels in the weak acid, thereby providing advantages.

In addition, an agglomerative characteristic and interfacial adhesion to strands of reinforcement fibers may be imparted by coating reinforcement fibers unwound from fiber-reinforced parts such as pressure vessels with a sizing agent mainly composed of resin. Accordingly, vessels may be manufactured with the reinforcement fibers that is recovered using the method as described herein and the recovered reinforcement fibers may be recycled efficiently.

Other aspects of the invention are disclosed infra.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 illustrates an exemplary apparatus for recovering reinforcement fibers according to an exemplary embodiment of the present invention; and

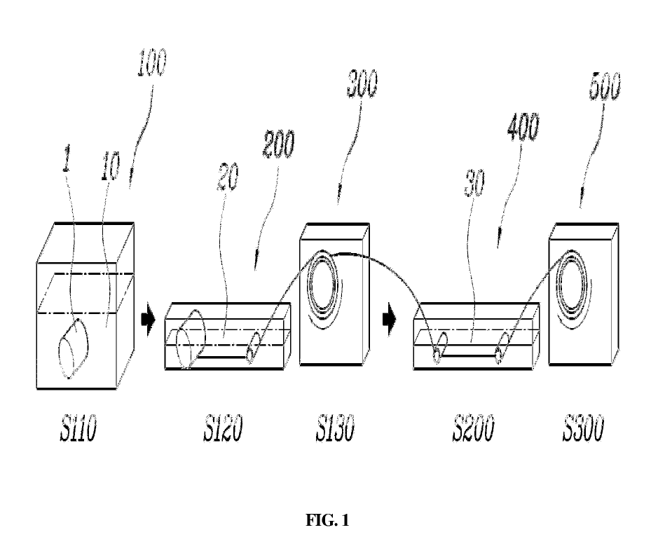

FIG. 2 illustrates an exemplary method of recovering reinforcement fibers according to an exemplary embodiment of the present invention.

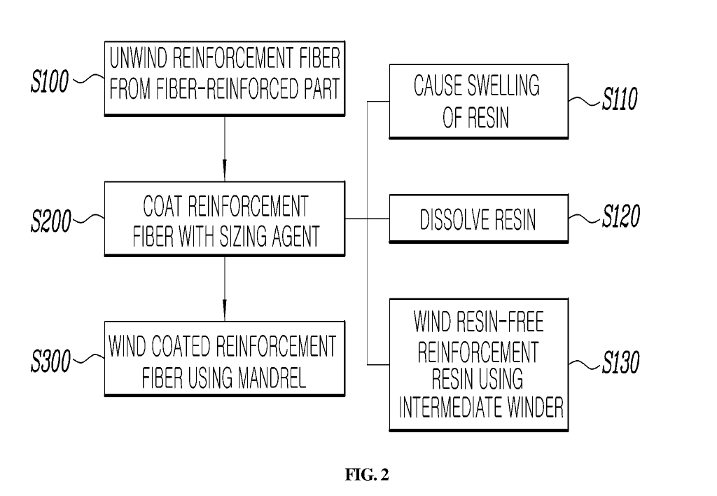

### DETAILED DESCRIPTION OF THE INVENTION

The terminology used herein is for the purpose of describing particular exemplary embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “ and/or” includes any and all combinations of one or more of the associated listed items. Unless specifically stated or obvious from context, as used herein, the term “ about” is understood as within a range of normal tolerance in the art, for example within 2 standard deviations of the mean. “ About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “ about.”

Herein, various exemplary embodiments of the present invention will be described in detail with reference to the accompanying drawings.

A method of recovering reinforcement fibers from waste fiber-reinforced parts according to an exemplary embodiment of the present invention may include steps of: a step S100 of separating resin from a fiber-reinforced part 1 including reinforcement fibers and impregnated with a resin and unwinding the reinforcement fibers from the fiber-reinforced part 1; a step S200 of coating the unwound reinforcement fibers with a sizing agent 30 by passing the unwound reinforcement fibers through the sizing agent 30; and a step S300 of winding the reinforcement fibers coated with the sizing agent 30 around a mandrel 500.

The fiber-reinforced part 1 may be a product that has a body wound by reinforcement fibers and impregnated with the resin. An example of the fiber-reinforced part 1 may be a pressure vessel that can contain liquid or gas having a pressure greater than an atmospheric pressure. Since fiber-reinforced parts have improved mechanical properties, they may be often used in the field of fuel cells. The fiber-reinforced part 1 may be manufactured through a filament winding method in which reinforcement fibers may be wound around a mandrel 500 or the like.

Waste fiber-reinforced parts such as waste pressure vessels that are made from expensive reinforcement fibers such as carbon fibers may need recycling in terms of cost of raw material.

There have been various studies on methods of recycling reinforcement fibers such as carbon fibers. However, in the related arts, the recovery methods may cause high cost for collection and treatment of reinforcement fibers. Furthermore, since strands of recovered reinforcement fibers such as carbon fibers may be tangled during thermal or chemical decomposition of the fiber-reinforced part 1, it may be difficult to recycle waste reinforcement fibers.

To recover these reinforcement fibers from the fiber-reinforced part 1, first, resin may be separated from the fiber-reinforced part 1 and reinforcement fibers may be unwound from the fiber-reinforced part 1 at Step S100 (unwinding).

The unwinding of reinforcement fibers from the fiber-reinforced part 1 may be the gist process. Step S100 (unwinding) may include: a step S110 at which the fiber-reinforced part 1 may be dipped in a swelling agent 10 so that resin impregnated in the fiber-reinforced part 1 may swell, a step S120 at which reinforcement fibers may be unwound from the fiber-reinforced part 1 and may pass through a dissolving agent 20 so that the resin impregnated in the fiber-reinforced part 1 may be dissolved, and a step S130 at which the resin-free reinforcement fibers may be wound by an intermediate winder 300.

Step S110 (swelling) may be a preparation step for unwinding of reinforcement fibers. At this step, the resin impregnated in the fiber-reinforced part 1 may be swelled. Conventionally, a strong acid such as nitric acid has been used to swell the resin, which may cause tangling of the unwound reinforcement fibers during recovery of reinforcement fibers.

Preferably, according to an exemplary embodiment of the present invention, the fiber-reinforced part 1 may be dipped in a weak acid with a pH of about 2.0 to 4.0, instead of a strong acid such as nitric acid, for swelling of resin. This may prevent tangling of reinforcement fibers. The weak acid may be acetic acid or formic acid. The swelling agent 10 may include any one of acetic acid and formic acid.

Next, the purpose of a step S120 may dissolve the resin that is swelled in the dissolving agent 20 by dipping the fiber-reinforced part 1. By separating the resin through the dissolution process and recovering waste reinforcement fibers, the recovered reinforcement fibers may be easily recycled. At a step S120 (dissolving), the reinforcement fibers may be continuously unwound. At this step S120, the dissolving agent 20 may include a hydrogen peroxide solution (also called oxygenated water) H₂O₂ and an ionic liquid. The hydrogen peroxide solution may dissolve resin and the ionic liquid may facilitate dissolution.

Preferably, the ionic liquid may include one or more cations selected from the group consisting of imidazolium, pyridinum, pyrrolidinium, quaternary ammonium, and quaternary phosphonium.

The reinforcement fibers that has undergone the dissolving the step S120 may be wound by the intermediate winder 300 at a step S130 (intermediate winding). The intermediate winder 300 may be installed to be close to a tank of the dissolving agent 20 so that work of unwinding reinforcement fibers from the fiber-reinforced part 1 and work of dissolving the resin impregnated in the fiber-reinforced part 1 may be continuously performed.

The tension of the reinforcement fibers that is wound by the intermediate winder 300 may be maintained to the extent that the reinforcement fibers may be unwound from the fiber-reinforced part 1.

The unwound reinforcement fibers after the unwinding process may pass through the sizing agent 30 at a step S200 so that the reinforcement fibers may be coated with the sizing agent 30. The purpose of Step S200 (sizing) may impart an agglomerative characteristic and interfacial adhesion to a bundle of the reinforcement fibers by coating the reinforcement fibers with the sizing agent 30 comprising a resin.

The reinforcement fibers coated with the sizing agent at Step S200 has an advantage in that it can be easily reused to manufacture a vessel or the like. The sizing agent 30 may be composed of water serving as a solvent and one or more resins selected from the group consisting of epoxy resin, polyurethane resin, polyester resin, polyamide resin, and nylon resin. The concentration of resin in the sizing agent may be of about 1.5 to 2.5 wt % based on the total weight of the sizing agent.

The above may provide an agglomerative characteristic and interfacial adhesion to the recovered reinforcement fibers.

Next, as a step S300 (winding), the reinforcement fibers coated with the sizing agent 30 may be wound around the mandrel 500. Thus, the recovery of reinforcement fibers from the fiber-reinforced part 1 may be completed so that the reinforcement fibers may be efficiently recycled. When winding the reinforcement fibers around the mandrel 500, the winding direction may be the same as in the winding process using the intermediate winder 300. That is, the reinforcement fibers may be unwound from the intermediate winder 300 and may be then rewound around the mandrel 500.

In order to efficiently recover the reinforcement fibers from the fiber-reinforced part 1 without intermittence, the tension of the reinforcement fibers that is wound around the mandrel 500 may be set to be weaker than that of the reinforcement fibers that is wound by the intermediate winder 300.

Since the intermediate winder 300 is used to unwind the reinforcement fibers from the fiber-reinforced part 1 and the mandrel 500 is used to unwind the reinforcement fibers from the intermediate winder 300 and to wind the reinforcement fibers therearound, the tension of the reinforcement fibers at the side of the intermediate winder 300 may be greater than the tension of the reinforcement fibers the side of at the mandrel 500. With this tension setting, the reinforcement fibers can be efficiently recovered without intermittence.

The reinforcement fibers (for example, continuous long fiber) recovered through the recovery method described above may be reused to form woven fabric, non-crimp fabric (NCF), braiding, a 3D toe reinforcing member, and the like.

An apparatus for recovering waste reinforcement fibers according to an exemplary embodiment of the present invention includes: a swelling tank 100 containing a swelling agent 10 swelling a resin impregnated in a fiber-reinforced part 1; a dissolving tank 200 containing a dissolving agent 200 including a hydrogen peroxide solution and an ionic liquid and dissolving the resin of the fiber-reinforced part 1; an intermediate winder 300 winding the resin-free reinforcement fibers coming out of the dissolving tank 200; a sizing tank 400 containing a sizing agent 30 coating the surface of the reinforcement fibers; and a mandrel 500 around which the sizing agent-coated reinforcement fibers that comes out of the sizing tank 400 is wound.

The apparatus may further include a tension adjuster that adjusts the tension of the reinforcement fibers such that the tension of the reinforcement fibers wound by the intermediate winder 300 may be greater than that of the reinforcement fibers wound by the mandrel 500.

With arrangement in which the swelling tank 100, a rotating means for rotating the fiber-reinforced part 1 during the swelling of the resin, the dissolving tank 200 containing the dissolving agent 20, the intermediate winder 300, the sizing tank 400 containing the sizing agent 30, and the rotatable mandrel 500 may be arranged in series in this order, the reinforcement fibers recovered from the fiber-reinforced part 1 may be continuously wound around the mandrel 500 without intermittence so that the recovered reinforcement fibers can be easily recycled.

In addition, in order to facilitate recovery of the reinforcement fibers from the fiber-reinforced part 1 without delay or intermittence, the tension of the reinforcement fibers at the side of the intermediate winder 300 may be set to be greater than the tension of the reinforcement fibers at the side of the mandrel 500. This tension setting may be enabled by arranging the tension adjuster at a position near the intermediate winder 300.

Although the above described exemplary embodiments of the present invention has been described for illustrative purposes, those skilled in the art will appreciate that various modifications, additions and substitutions are possible, without departing from the scope and spirit of the invention as disclosed in the accompanying claims.

What is claimed is:

1. A method of recovering reinforcement fibers from a fiber-reinforced part, the method comprising:
unwinding reinforcement fibers from a fiber-reinforced part, wherein the fiber-reinforced part includes the reinforcement fibers and is impregnated with a resin;
coating the unwound reinforcement fibers with a sizing agent by passing the unwound reinforcement fibers through the sizing agent; and
winding the sizing agent-coated reinforcement fibers around a mandrel.

2. The method according to claim 1,
wherein the unwinding includes:
swelling the resin by dipping the fiber-reinforced part in a swelling agent;
dissolving the resin by passing the unwound reinforcement fibers through a dissolving agent as unwinding the reinforcement fibers from the fiber-reinforced part; and
winding the resin-free reinforcement fibers using an intermediate winder.

3. The method according to claim 2, wherein the swelling agent is a weak acid.

4. The method according to claim 2, wherein the dissolving agent comprises a hydrogen peroxide solution and an ionic liquid.

5. The method according to claim 2, wherein a tension of the reinforcement fibers wound by the intermediate winder is greater than a tension of the reinforcement fibers wound around the mandrel.

6. The method according to claim 1, wherein the sizing agent comprise one or more resins selected from the group consisting of epoxy resin, polyurethane resin, polyester resin, polyamide resin, and nylon resin.

7. An apparatus for recovering reinforcement fibers from a waste fiber-reinforced part, the apparatus comprising:
a swelling tank containing a swelling agent comprising a weak acid and swelling a resin impregnated in the fiber-reinforced part;
a dissolving tank containing a dissolving agent that includes a hydrogen peroxide solution and an ionic liquid and that dissolves the resin impregnated in the fiber-reinforced part;
an intermediate winder winding the reinforcement fibers from which the resin is removed;
a sizing tank containing a sizing agent by which the resin-free reinforcement fibers are coated; and
a mandrel around which the coated reinforcement fibers are wound.

8. The apparatus according to claim 7, further comprising a tension adjuster that adjusts a tension of the reinforcement fibers such that a tension of the reinforcement fibers wound by the intermediate winder is greater than a tension of the reinforcement fibers wound by the mandrel.
